(19) United States
(12) Patent Application Publication
(10) Pub. No.: US 2020/0400790 A1
(43) Pub. Date: Dec. 24, 2020

(54) ELECTRONIC APPARATUS AND DISTANCE MEASURING METHOD

(71) Applicants: KABUSHIKI KAISHA TOSHIBA, Minato-ku (JP); TOSHIBA ELECTRONIC DEVICES & STORAGE CORPORATION, Minato-ku (JP)

(72) Inventors: Kentaro YOSHIOKA, Kawasaki (JP); Hiroshi KUBOTA, Kawasaki (JP)

(73) Assignees: KABUSHIKI KAISHA TOSHIBA, Minato-ku (JP); TOSHIBA ELECTRONIC DEVICES & STORAGE CORPORATION, Minato-ku (JP)

(21) Appl. No.: 16/818,170

(22) Filed: Mar. 13, 2020

(30) Foreign Application Priority Data
Jun. 18, 2019 (JP) 2019-112765

(51) Int. Cl. G01S 7/4861; G01S 7/4865

(52) U.S. Cl. CPC G01S 7/4861; G01S 7/4865

(57) ABSTRACT

An electronic apparatus has a light receiver configured to receive a reception light including a reflected pulse generated by a reflection of an emitted pulse on an object, an analog-to-digital converter configured to generate digital signals regarding the reception light, a memory configured to store the digital signals, a memory controller configured to control a write rate to write the digital signals to the memory in accordance with an elapsed time from emission timing of the emitted pulse; and processor circuitry configured to measure a distance to the object based on a difference between the emission timing of the emitted pulse and reception timing of the reflected pulse.

### CROSS REFERENCE TO RELATED APPLICATIONS

This application is based upon and claims the benefit of priority from the prior Japanese Patent Application No. 2019-112765, filed on Jun. 18, 2019, the entire contents of which are incorporated herein by reference.

### FIELD

Embodiments described herein relate generally to an electronic apparatus and a distance measuring method.

### BACKGROUND

A technique to measure the distance to an object is known, in which a laser beam is emitted to the object and the distance to the object is measured based on emission timing at which the laser beam is emitted and reception timing at which a reflected laser beam from the object is received. This technique has been attracting attention as being indispensable for collision prevention or automatic driving of vehicles since the use of such a technique enables a high-speed and contactless detection of a distance to an obstacle around a vehicle.

A reflected laser beam from the object is received together with ambient light such as sunlight. It is therefore difficult to distinguish the reflected laser beam from the ambient light if the light intensity of the reflected laser beam is weak. In order to accurately distinguish the reflected laser beam from the ambient light, it may be necessary to convert the reception signal to a digital signal, store the digital signal in a memory, and perform signal processing such as averaging on the digital signal. In recent years, there has been a demand to increase the distance to objects that can be measured. In order to meet the demand, a large amount of pixel data corresponding to the received light should be stored. This requires a large capacity memory, which leads to an increase in facility costs. In particular, when the above-described distance measuring function is intended to be achieved by a system on chip (SoC) module, an increase in capacity of memory may make it difficult to form a chip.

If, however, the sampling rate of analog-to-digital conversion of an electrical signal outputted from a light receiver is decreased to reduce the capacity of the memory, the measured distance error may be increased.

### BRIEF DESCRIPTION OF THE DRAWINGS

FIG. 1 is a block diagram illustrating a schematic configuration of an electronic apparatus according to a first embodiment.

FIG. 2 is a diagram showing the relationship between the sampling rate of an analog-to-digital converter and the measured distance error.

FIG. 3 is a diagram showing changes in sampling rate as the time elapses from emission timing.

FIG. 4 is a flowchart of an operation of the electronic apparatus according to the first embodiment.

FIG. 5 is a diagram for explaining the operation of a distance measurer.

FIG. 6 is a flowchart of an operation of an electronic apparatus according to a second embodiment.

FIG. 7 is a block diagram illustrating a schematic configuration of an electronic apparatus according to a third embodiment.

FIG. 8 is a diagram showing an example of the relationship between the distance to an object and the sampling rate.

FIG. 9 is a flowchart of an operation of the electronic apparatus according to the third embodiment.

FIG. 10 is a flowchart of an operation of an electronic apparatus according to a fourth embodiment.

FIG. 11 is a flowchart of an operation of an electronic apparatus 1 according to a fifth embodiment.

### DETAILED DESCRIPTION

An electronic apparatus according to one embodiment has a light receiver configured to receive a reception light including a reflected pulse generated by a reflection of an emitted pulse on an object, an analog-to-digital converter configured to generate digital signals regarding the reception light, a memory configured to store the digital signals, a memory controller configured to control a write rate to write the digital signals to the memory in accordance with an elapsed time from emission timing of the emitted pulse; and processor circuitry configured to measure a distance to the object based on a difference between the emission timing of the emitted pulse and reception timing of the reflected pulse.

Embodiments of an electronic apparatus and a distance measuring method will now be described with reference to the accompanying drawings. Although most of the following descriptions are for the main part of the electronic apparatus, other parts or functions that are not illustrated or explained may be included in the electronic apparatus.

### First Embodiment

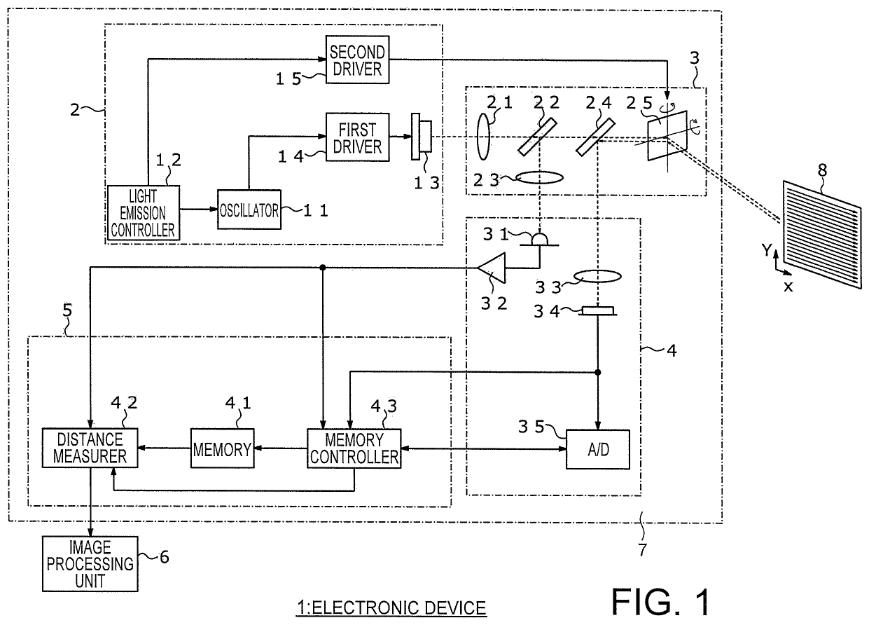

FIG. 1 is a block diagram illustrating a schematic configuration of an electronic apparatus 1 according to a first embodiment. The electronic apparatus 1 shown in FIG. 1 may be mounted on a movable object such as a vehicle. The scope of the movable object includes not only vehicles but also ships, aircrafts, and trains, for example. In the following descriptions, the electronic apparatus 1 shown in FIG. 1 is mounted on a vehicle.

The electronic apparatus 1 shown in FIG. 1 includes a light emitter 2, a light controller 3, a light receiver 4, a signal processing unit 5, and an image processing unit 6. The light emitter 2, the light controller 3, the light receiver 4, and the signal processing unit 5 constitute a distance measuring device 7. Examples in which the distance measuring device 7 measures a distance by a scanning method and by a time of flight (TOF) method will be described below. At least a part of the electronic apparatus 1 shown in FIG. 1 may be formed of one or more semiconductor integrated circuits (ICs). For example, the signal processing unit 5 and the image processing unit 6 may be integrated into one semiconductor chip. The semiconductor chip may further include the light receiver 4, and may still further include the light emitter 2.

The light emitter 2 emits a first light, which is a laser beam having a predetermined frequency band, for example. A laser beam is coherent light with uniform phase and frequency. The light emitter 2 intermittently emits pulses of the first light at a predetermined cycle. The cycle in which the light emitter 2 emits the first light is longer than the period of time in which the distance measuring device 7 measures a distance based on one pulse of the first light.

The light emitter 2 includes an oscillator 11, a light emission controller 12, a light source 13, a first driver 14, and a second driver 15. The oscillator 11 generates an oscillation signal in accordance with the cycle for emitting the first light. The first driver 14 intermittently supplies power to the light source 13 in synchronization with the oscillation signal. The light source 13 intermittently emits the first light using the power from the first driver 14. The light source 13 may be a laser element that emits a single laser beam, or a laser unit that emits a plurality of laser beams at a time. The light emission controller 12 controls the second driver 15 in synchronization with the oscillation signal. The second driver 15 supplies a drive signal in synchronization with the oscillation signal to the light controller 3 in accordance with a command from the light emission controller 12.

The light controller 3 controls the direction of the first light emitted from the light source 13. The light controller 3 also controls the direction of a second light to be received.

The light controller 3 includes a first lens 21, a beam splitter 22, a second lens 23, a half mirror 24, and a scan mirror 25.

The first lens 21 collects the first light emitted from the light emitter 2 and guides the collected first light to the beam splitter 22. The beam splitter 22 splits the first light from the first lens 21 into two directions, and guides the split lights to the second lens 23 and the half mirror 24. The second lens 23 guides one of the split lights (first split light) from the beam splitter 22 to the light receiver 4. The reason why the first light is guided to the light receiver 4 is to detect the emission timing at the light receiver 4.

The half mirror 24 transmits the other of the split lights (second split light) from the beam splitter 22 and guides it to the scan mirror 25. The half mirror 24 reflects the second light, which includes reflected light entering the electronic apparatus 1, toward the light receiver 4.

The scan mirror 25 rotates its mirror surface in synchronization with the drive signal from the second driver 15 included in the light emitter 2. As a result, the direction of the reflection of a second split light (of the first light), which passes through the half mirror 24 and is incident on the mirror surface of the scan mirror 25, is controlled. The first light emitted from the light controller 3 may be sent for scan in at least one-dimensional direction by rotating the mirror surface of the half mirror 24 at a constant frequency. The first light may be emitted from the light controller 3 in two directions if two axes are provided to rotate the mirror surface. In FIG. 1, the scan mirror 25 sends the first light emitted from the electronic apparatus 1 in an X direction and a Y direction for scan.

If an object 8 such as a human or a solid material is present in a scanning range of the first light emitted from the electronic apparatus 1, the first light is reflected on the object 8. At least part of the reflected light from the object 8 moves along a path that is substantially the same as the path of the first light, and is incident on the scan mirror 25 included in the light controller 3. The mirror surface of the scan mirror 25 is rotated at a constant frequency. However, since the laser beam travels at light speed, the reflected light from the object 8 is incident on the mirror surface while the angle of the mirror surface of the scan mirror 25 is substantially unchanged. After being incident on the mirror surface, the reflected light from the object 8 is reflected on the half mirror 24 and received by the light receiver 4.

The light receiver 4 includes a photodetector 31, an amplifier 32, a third lens 33, a light receiving sensor 34, and an analog-to-digital converter 35. The photodetector 31 receives the first split light (of the first light) from the beam splitter 22 and converts it to an electrical signal. The photodetector 31 detects emission timing at which the first light is emitted. The amplifier 32 amplifies the electrical signal outputted from the photodetector 31.

The third lens 33 focuses the second light reflected on the half mirror 24 to form an image on the light receiving sensor 34. The light receiving sensor 34 receives the second light and converts it to an electrical signal. The light receiving sensor 34 may be a silicon photomultiplier (SiPM), for example. The SiPM is a photo-sensing element including avalanche photodiodes (APD) that are two-dimensionally arranged in an array form. A reverse-bias voltage that is higher than a breakdown voltage of the APDs is applied to operate the SiPM in a region called “Geiger mode.” The gain of the APDs in the Geiger mode is very high. Therefore, a slight light of one photon may be measured. The electrical signal obtained by the photoelectric conversion at the light receiving sensor 34 is further converted to a digital signal at the analog-to-digital converter 35.

The analog-to-digital converter 35 samples electrical signals outputted from the light receiving sensor 34 at a predetermined sampling rate, and analog-to-digital (A/D) converts the sampled electrical signals to generate digital signals. The analog-to-digital converter 35 may switch the sampling rate. As the sampling rate becomes higher, the number of digital signals outputted from the analog-to-digital converter 35 per unit time increases. The analog-to-digital converter 35 according to the first embodiment changes the sampling rate as the time passes from the emission timing, in a manner that as the elapsed time is shorter, the sampling rate is higher, and as the elapsed time is longer, the sampling rate is lower in at least a limited period of time. As the sampling rate of the analog-to-digital converter 35 is higher, the electrical signals outputted from the light receiving sensor 34 may be A/D converted more faithfully, which may decrease the difference between the electrical signal and the digital signal. The sampling rate, however, may be temporarily set higher in a predefined period of time as an exception. This will be described in detail later in the descriptions of a fifth embodiment.

The signal processing unit 5 measures a distance to the object 8 that reflects the first light, and stores a digital signal corresponding to the second light in a memory 41. The signal processing unit 5 includes the memory 41, a distance measurer 42, and a 1 43.

The distance measurer 42 measures the distance to the object 8 based on the first light and the reflected light. More specifically, the distance measurer 42 measures the distance to the object 8 based on a difference in time between the emission timing at which the first light is emitted and the reception timing at which the reflected light included in the second light is received by the light receiving sensor 34. The distance measurer 42 measures the distance based on the following expression (1).

Distance=Light Speed×(reflected light reception timing−first light emission timing)/2 (1)

The “reflected light reception timing” in the expression (1) is the reception timing indicated by the peak position of the reflected light. The distance measurer 42 detects the peak position of the reflected light included in the second light based on the digital signal generated by the analog-to-digital converter 35. The timing of the peak position of the reflected light may be detected more accurately if the sampling rate of the analog-to-digital converter 35 is higher. If the sampling rate of the analog-to-digital converter 35 is low, the timing of the peak position of the reflected light may not be detected accurately. Therefore, the error in the measured distance to the object may become greater.

Assuming that the sampling rate of the analog-to-digital converter 35 is fs, for example, the interval between the sampling instants may be obtained by the following expression (2).

tfs=1/fs (2)

A maximum error in the measured distance caused by a finite sampling rate can be obtained by the following expression (3).

Error in Measured Distance=tfs×Light Speed (3)

If the sampling rate fs is 100 MHz and the light speed is 3×10⁸ m/s, for example, the error in the measured distance obtained by the expression (3) is 3 m. Thus, the error in the measured distance is inversely proportional to the sampling rate fs, and therefore may be decreased by increasing the sampling rate fs of the analog-to-digital converter 35. In general, if the sampling rate is low, the peak position may be detected by averaging the sampled data items of a plurality of adjacent sampling points. Therefore, the error of the measured distance becomes smaller than 3 m.

The distance measurer 42 may also measure the distance to the object 8 using information on the second light received at a first point in time, and information on the second light received at a second point in time stored in the memory 41, the second point in time being earlier than the first point in time. Since the second light received by the light receiver 4 includes a component of noise light such as ambient light, the information on the second light received in the past may help a more accurate extraction of the reflected light included in the second light, thereby improving the accuracy of the distance measurement.

The memory 41 stores the digital signals outputted from the light receiving sensor 34. The memory controller 43 controls the write rate at which the digital signals are stored in the memory 41 depending on the period of time from the emission timing at which the first light is emitted to the reception of the second light. More specifically, the memory controller 43 reduces the write rate continuously or stepwise as the time elapsed from the emission timing becomes longer. Accordingly, as the time passes, the number of digital signals stored in the memory 41 in a unit time decreases. This may curb the amount of data stored in the memory 41. The memory controller 43 according to the first embodiment controls the sampling rate of the analog-to-digital converter 35 according to the time elapsed from the emission timing to the reception of the second light. The write rate at which the digital signals outputted from the analog-to-digital converter 35 are stored in the memory 41 may be controlled by controlling the sampling rate of the analog-to-digital converter 35.

The image processing unit 6 generates a distance image, for example, based on the distance measured by the distance measurer 42 included in the signal processing unit 5. In a distance image, each object located in front of and in a predetermined range of a vehicle on which the electronic apparatus 1 is mounted and the distance to the object have a color that is different from the color of another object and its distance for the purpose of the viewing convenience.

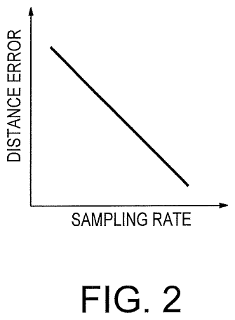

FIG. 2 is a diagram showing the relationship between the sampling rate of the analog-to-digital converter 35 and the measured distance error. In FIG. 2, the horizontal axis represents the sampling rate, and the vertical axis represents the measured distance error. As shown in FIG. 2, the sampling rate is in linear relationship with the measured distance error. If the sampling rate of the analog-to-digital converter 35 is increased, the measured distance error may be reduced. However, in order to do so, the analog-to-digital converter 35 needs to operate at a high speed. This makes it difficult to design the analog-to-digital converter 35 and increases the power consumption of the analog-to-digital converter 35. Furthermore, if the sampling rate of the analog-to-digital converter 35 becomes high, the amount of data of the digital signals generated by the analog-to-digital converter 35 increases in proportion to the sampling rate, thereby increasing the storage capacity of the memory 41.

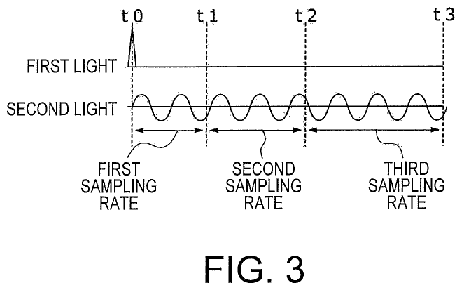

In order to solve this problem, in the first embodiment, the sampling rate of the analog-to-digital converter 35 for sampling the electrical signals outputted from the light receiving sensor 34 is changed as the time passes from the emission timing. FIG. 3 is a diagram showing changes in the sampling rate as the time elapses from the emission timing t0. As shown in FIG. 3, the electrical signals outputted from the light receiving sensor 34 are sampled at a first sampling rate from the emission timing t0 at which the first light is emitted from the light emitter 2 to a first point in time t1, at a second sampling rate that is lower than the first sampling rate from the first point in time t1 to a second point in time t2, and at a third sampling rate that is lower than the second sampling rate after the second point in time t2. Thus, as the time passes from the emission timing, the sampling cycle for sampling the electrical signals emitted from the light receiving sensor 34 is elongated. As a result, if the object is located nearby, the distance to the object may be detected accurately, and if the object is located at a distance, the approximate distance to the object may be detected without increasing the storage capacity of the memory 41.

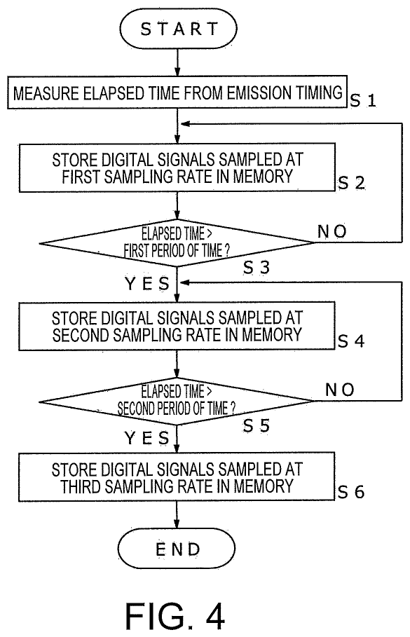

FIG. 4 is a flowchart showing an operation of the electronic apparatus 1 according to the first embodiment. The flowchart of FIG. 4 shows the operation from the emission of the first light by the light emitter 2 to the storage of the digital signal corresponding to the second light received by the light receiving sensor 34 in the memory 41.

When the light emitter 2 emits the first light, the measurement of the lapse of time from the emission timing starts (step S1). The measurement of the elapsed time is performed by the memory controller 43, for example.

The light receiving sensor 34 then continuously receives the second light and converts it to the electrical signal. Since the electrical signal is an analog signal, it is converted to a digital signal at the analog-to-digital converter 35. In the initial state, the analog-to-digital converter 35 samples the electrical signals outputted from the light receiving sensor 34 at the first sampling rate and converts the sampled electrical signals to digital signals. If it is determined from the magnitude of the digital signals that the received second light includes the reflected light from the object, a digital signal corresponding to the reflected light is stored in the memory 41 (step S2). If the reflected light is received within a short time from the emission of the first light, the object is considered to be present near the distance measuring device 7. If the object is present nearby, the distance to the object needs to be measured more precisely. Therefore, the first sampling rate set in the initial state should be as high as possible. Since a plurality of digital signals sampled in a short time intervals for the reflected light component are stored in the memory 41, as the first sampling rate becomes higher, the storage capacity of the memory 41 becomes greater. Therefore, it is not preferable that a long period of time is set for performing the sampling at the first sampling rate.

Then, whether the elapsed time from the emission timing is longer than a first period of time is determined (step S3). For example, the first period of time is a period from the emission of the first light to a point in time when the reflected light from an object located at a distance of about 20 m is received by the light receiving sensor 34. Since the distance to the object at a distance of about 20 m needs to be measured as accurately as possible, if the elapsed time is within the first period of time, the processes of steps S2 and S3 are repeated at the first sampling rate.

If it is determined that the elapsed time is longer than the first period of time, the electrical signals corresponding to the second light outputted from the light receiver are sampled at the second sampling rate and the sampled signals are converted to digital signals. If it is estimated that the second light includes the reflected light from the object, the digital signals sampled at the second sampling rate are stored in the memory 41 (step S4). Since the second sampling rate is lower than the first sampling rate, the frequency at which the digital signals are stored in the memory 41 is reduced, thereby reducing the amount of data stored in the memory 41 in a unit time.

Then, it is determined whether the elapsed time from the emission timing is longer than a second period of time, which is longer than the first period of time (step S5). More specifically, the second period of time is, for example, a period from the emission of the first light to a point in time at which the reflected light from an object at a distance of about 200 m is received by the light receiving sensor 34. The allowable range of the measured distance error for an object that is at a distance between 20 m and 200 m from a vehicle on which the distance measuring device 7 is mounted is wider than that for an object at a distance of within 20 m. Therefore, if the elapsed time is within the second period of time, the processes of steps S4 and S5 are repeated at the second sampling rate.

If it is determined that the elapsed time is longer than the second period of time, the electrical signals are sampled at a third sampling rate and converted to a digital signal. If it is estimated that the second light contains the reflected light from the object, the digital signals sampled at the third sampling rate are stored in the memory 41 (step S5). Since the third sampling rate is lower than the second sampling rate, the frequency at which the digital signals are stored in the memory 41 is reduced further, thereby further reducing the amount of data stored in the memory 41 in a unit time. If the object is located at a distance of 200 m or more, for example, there is no practical problem when the error in the measured distance to the object may be large to some extent. Therefore, if the distance to the object is long, the sampling rate of the analog-to-digital converter 35 is reduced to lower the frequency at which the digital signals are stored in the memory 41.

FIGS. 3 and 4 show an example in which three sampling rates (first to third sampling rates) are used. However, the elapsed time from the emission timing may be divided into shorter periods, and four or more sampling rates may be used depending on the elapsed time. Alternatively, two sampling rates may be used and switched depending on whether the elapsed time is longer than a predetermined period of time. Furthermore, depending on the time and the circumstance, the value of the sampling rate and the lengths of the first period of time and the second period of time may be changed.

A function for defining the relationship between the elapsed time and the sampling rate may be generated, and the sampling rate corresponding to elapsed time may be calculated by inputting the elapsed time to the function. The use of such a function allows continuous changes in sampling rate in accordance with the elapsed time. Alternatively, a table for defining the relationship between the elapsed time and the sampling rate may be generated, and the sampling rate corresponding to elapsed time may be selected by referring to the table. The use of such a table allows stepwise changes in sampling rate in accordance with the elapsed time.

The distance measurer 42 measures the distance to the object based on the time difference between the emission timing and the peak of the signal corresponding to the reflected light included in the second light. Since there are several sampling rates for sampling the electrical signals outputted from the light receiving sensor 34 in the first embodiment, the distance measurer 42 needs to have information on the changes in sampling rate in accordance with the elapsed time in advance. If the memory controller 43 determines the sampling rate that is suitable for the elapsed time, the above-described information needs to be notified to the analog-to-digital converter 35 and the distance measurer 42.

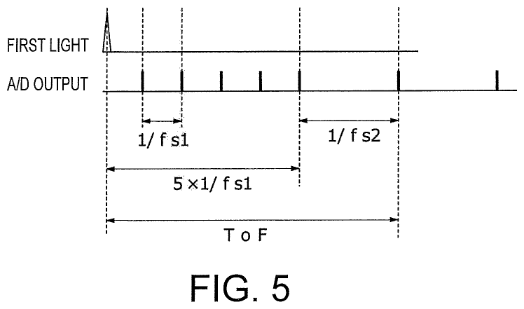

FIG. 5 is a diagram for explaining the operation of the distance measurer 42. In the example of FIG. 5, if the peak of the reflected signal is detected at the sixth sampling of the analog-to-digital converter 35 after the emission of the first light by the light emitter 2, the distance measurement information ToF may be indicated by the following expression (4) if the sampling rate fs is fixed.

ToF=6×1/fs (4)

If the sampling rate may be changed as in the first embodiment, and the sampling rate for the first to fifth sampling occasions is fs1 and the sampling rate at and after the sixth sampling is fs2, the distance measurement information ToF may be indicated by the following expression (5).

ToF=5×1/fs1+1×1/fs2 (5)

As can be understood from the expression (5), the distance measurer 42 may easily measure the distance to the object based on the relationship between the elapsed time and the sampling rate.

In the above-described example shown in FIGS. 3 and 4, the sampling rate of the analog-to-digital converter 35 is changed continuously or stepwise based on the elapsed time from the emission timing. The elapsed time from the emission timing is equal in meaning to the time of flight from the emission of the first light to the point in time when the reflected light is received at the light receiver 4. Thus, the distance measuring device 7 according to the first embodiment changes the sampling rate of the analog-to-digital converter 35 continuously or stepwise based on the length of the time of flight of the first light and its reflected light.

The switching of the sampling rate of the analog-to-digital converter 35 according to the first embodiment may be performed by adjusting the operation clock frequency of the analog-to-digital converter 35. For example, if the sampling rate needs to be reduced to 1/2.5, the operation clock frequency is reduced to 1/2.5. The operation clock frequency of the analog-to-digital converter 35 may be controlled relatively easily by a clock generation circuit including a phase looked loop (PLL) circuit. The clock generation circuit may include a plurality of PLL circuits each generating a clock signal having a different frequency, and may switch the PLL circuit to be used.

As described above, in the first embodiment, the sampling rate for sampling the electrical signals outputted from the light receiving sensor 34 is changed based on the elapsed time from the emission timing at which the first light is emitted. Since the sampling rate may be reduced as the time passes, the number of digital signals stored in the memory 41 may be curbed. If the elapsed time is short, the sampling rate is high. Therefore, if the distance to the object is short, the accuracy in measuring the distance may be improved. If the elapsed time is long, the sampling rate is low. Therefore, the number of digital signals stored in the memory 41 may be reduced although the accuracy in measuring the distance may be degraded.

### Second Embodiment

In the first embodiment, the sampling rate for sampling the electrical signals outputted from the light receiving sensor 34 is changed based on the elapsed time from the emission timing. However, the sampling rate may be fixed, and the downsampling rate of the sampled digital signals may be changed as the time passes. The “downsampling rate” here means a value indicating the degree of digital signals outputted from the analog-to-digital converter 35 and not stored in the memory 41. As the downsampling rate is higher, the number of digital signals stored in the memory 41 is smaller, and as the downsampling rate is lower, the number of digital signals stored in the memory 41 is larger. In the second embodiment, the downsampling rate of the digital signal is set to become higher as the time passes, thereby curbing an increase in the storage capacity of the memory 41.

The electronic apparatus 1 according to the second embodiment has the block configuration shown in FIG. 1. However, the operations of the analog-to-digital converter 35 in the light receiver 4 and the memory controller 43 in the signal processing unit 5 are different from those of the first embodiment.

The analog-to-digital converter 35 according to the second embodiment samples the electrical signals outputted from the light receiving sensor 34 at a constant sampling rate regardless of the elapsed time from the emission timing. Therefore, the analog-to-digital converter 35 outputs digital signals at constant time intervals regardless of the elapsed time from the emission timing. The digital signals outputted from the analog-to-digital converter 35 are inputted to the memory controller 43.

The memory controller 43 changes the downsampling rate of the digital signals based on the elapsed time from the emission timing. More specifically, the memory controller 43 sets the downsampling rate to be low if the elapsed time is short to store an increased number of digital signals in the memory 41 in a unit time. On the other hand, the memory controller 43 sets the downsampling rate to be high if the elapsed time is long to store a reduced number of digital signals in the memory 41 in the unit time.

As a result, as the elapsed time from the emission timing becomes longer, the frequency at which the digital signals are stored in the memory 41 is reduced, thereby curbing the storage capacity of the memory 41 for storing the digital signals.

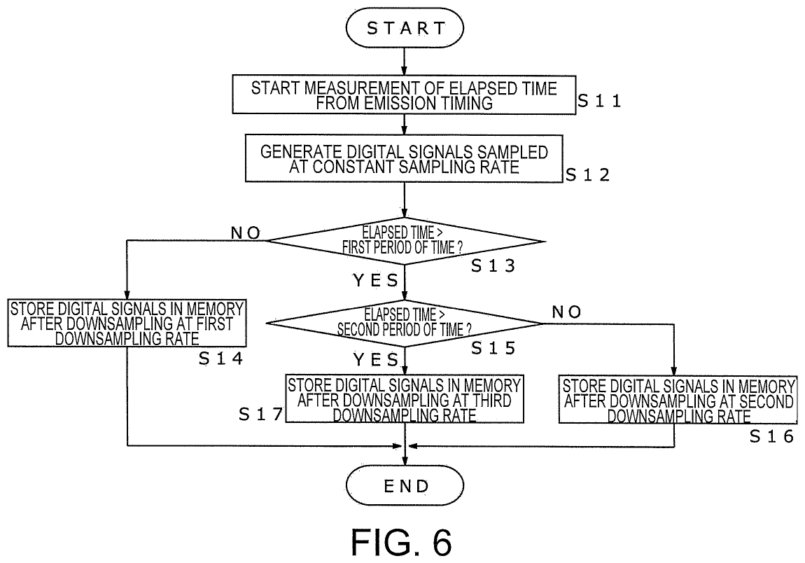

FIG. 6 is a flowchart of an operation of the electronic apparatus 1 according to the second embodiment. After the measurement of the time passing from the emission timing starts (step S11), the analog-to-digital converter 35 samples electrical signals outputted from the light receiving sensor 34 at a constant sampling rate and generates digital signals (step S12). If a digital signal corresponding to a component of a reflected light from an object is included in the sampled digital signals, the memory controller 43 determines whether the elapsed time from the emission timing is longer than a first period of time (step S13). If the elapsed time is not longer, the memory 41 stores the digital signals at a first downsampling rate (step S14). The first downsampling rate may be zero. On such an occasion, the memory controller 43 causes the memory 41 to store all the digital signals sampled by the analog-to-digital converter 35 at the constant sampling rate.

If it is determined at step S13 that the elapsed time is longer than the first period of time, whether the elapsed time is longer than a second period of time is then determined (step S15). If it is determined that the elapsed time is not longer than the second period of time, the digital signals are reduced at a second downsampling rate and stored in the memory 41 (step S16). The second downsampling rate is higher than the first downsampling rate. Therefore, the number of digital signals reduced at the second downsampling rate is greater than the number of digital signals reduced at the first downsampling rate. As a result, the frequency at which the digital signals are stored in the memory 41 may be reduced, thereby curbing the storage capacity of the memory 41 for storing the digital signals.

If it is determined at step S15 that the elapsed time is longer than the second period of time, the digital signals are reduced at a third downsampling rate and stored in the memory 41 (step S17). The third downsampling rate is higher than the second downsampling rate. Therefore, the number of digital signals reduced at the third downsampling rate is greater than the number of digital signals reduced at the second downsampling rate. Such digital signals are stored in the memory 41. This further curbs the storage capacity of the memory 41 for storing the digital signals.

As described above, in the second embodiment, the number of digital signals that are obtained by A/D conversion after electronic signals are sampled at a constant sampling rate is reduced at a downsampling rate determined based on the elapsed time from the emission timing, and the downsampled digital signals are stored in the memory 41. Therefore, as the time passes, the frequency at which the digital signals are stored in the memory 41 may be reduced, thereby curbing the number of digital signals stored in the memory 41. Since the analog-to-digital converter 35 according to the second embodiment samples electronic signals at a constant sampling rate before performing the A/D conversion, the operation of the analog-to-digital converter 35 may be simplified.

### Third Embodiment

In the first and second embodiments described above, the write rate for storing digital signals in the memory 41 is controlled in accordance with the elapsed time from the emission timing. The write rate may be controlled, however, based on the distance to the object.

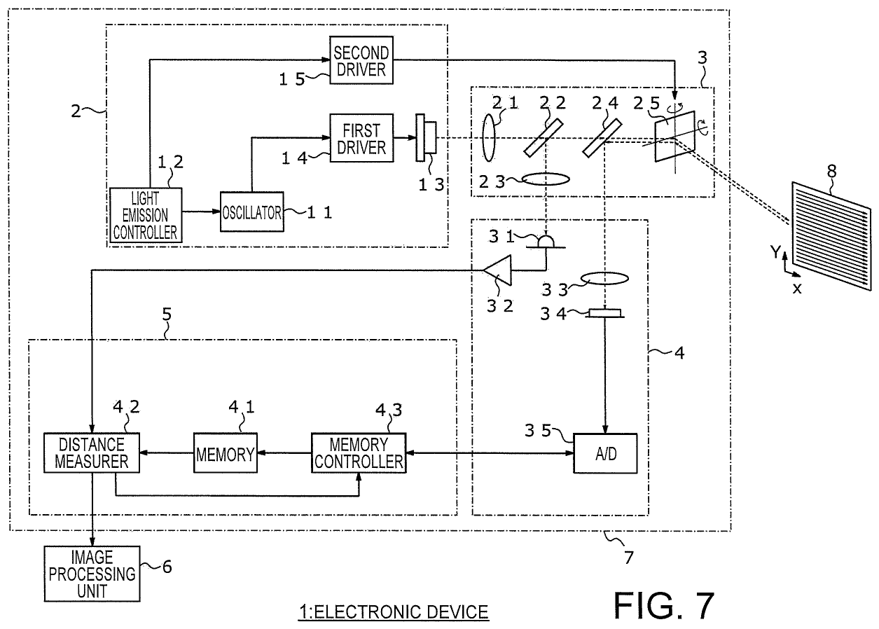

FIG. 7 is a block diagram illustrating a schematic configuration of an electronic apparatus 1 according to a third embodiment. The operations of the distance measurer 42 and the memory controller 43 included in the electronic apparatus 1 shown in FIG. 7 are partially different from those of the electronic apparatus shown in FIG. 1. As will be described later, the sampling rate of the analog-to-digital converter 35 is changed based on the distance to the object in the third embodiment. Therefore, the distance information on the distance to the object measured by the distance measurer 42 is inputted to the memory controller 43. The memory controller 43 according to the third embodiment controls the write rate for storing digital signals in the memory 41 based on the distance to the object. The write rate may be controlled by changing the sampling rate at the analog-to-digital converter 35.

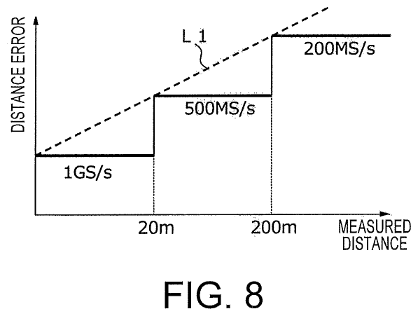

FIG. 8 is a diagram showing an example of the relationship between the distance to an object and the sampling rate. In the example shown in FIG. 8, the sampling rate is 1 GS/s when the distance to an object is equal to or less than 20 m, 500 MS/s when the distance is from 20 m to 200 m, and 200 MS/s when the distance is more than 200 m. FIG. 8 shows only an example of the relationship, and the sampling rate and the distance may be arbitrarily changed.

The broken line in FIG. 8 is a linear line L1 indicating the measured distance error that may be allowed in the measurement. The measured distance error is allowed if the value thereof is below the linear line. The allowable range of the measured distance error becomes narrower as the distance to the object becomes shorter. In such a range, a slight measured distance error cannot be allowed. On the other hand, as the distance to the object becomes longer, the allowable range of the measured distance error becomes wider.

As can be understood from FIG. 8, if the sampling rate of the analog-to-digital converter 35 is reduced, the measured distance error becomes greater. In the third embodiment, the relationship between the distance to the object and the sampling rate has a linear characteristic changed stepwise so that the measured distance error becomes smaller than the corresponding value on linear broken line L1 shown in FIG. 8. More specifically, if the distance to the object is short, the sampling rate is set as high as possible, and as the distance to the object becomes longer, the sampling rate is reduced stepwise.

In the third embodiment, the distance to the object is measured by the distance measurer 42 in advance. The distance measurer 42 basically measures the distance to the object based on a time difference between the emission timing and a point in time at which the reflected light included in the second light has a peak. When the sampling rate of the analog-to-digital converter 35 is determined, the distance measurer 42 may measure the distance to the object by a method that is different from the method described above. For example, the distance to the object may be measured using radar that transmits and receives millimeter waves. Furthermore, the distance to the object may be measured based on an image taken by an imaging unit.

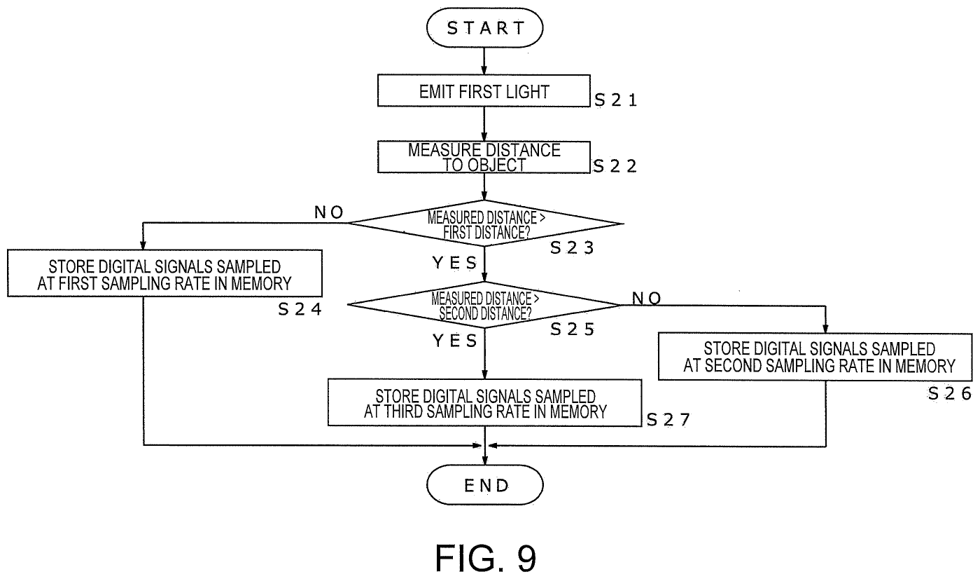

FIG. 9 is a flowchart of an operation of the electronic apparatus 1 according to the third embodiment. After the first light is emitted (step S21), the distance measurer 42 measures the distance to an object by any means (step S22). Whether or not the measured distance is longer than a first distance is then determined (step S23). If it is determined at step S23 that the distance is not longer than the first distance, electrical signals outputted from the light receiving sensor 34 are sampled at a first sampling rate and sampled signals are A/D converted to generate digital signals. If the digital signals include a digital signal based on a component of the reflected light from the object, the digital signal is stored in the memory 41 (step S24). If it is determined at step S23 that the distance is longer than the first distance, whether the measured distance is longer than a second distance is determined (step S25). The second distance is longer than the first distance. If it is determined at step S25 that the measured distance is not longer than the second distance, electronic signals are sampled at a second sampling rate and sampled signals are A/D converted to generate digital signals. If the digital signals include a digital signal based on a component of the reflected light from the object, the digital signal is stored in the memory 41 (step S26). The second sampling rate is lower than the first sampling rate. As a result, the frequency at which the digital signals are stored in the memory 41 becomes lower than the frequency at step S24.

If it is determined at step S25 that the measured distance is longer than the second distance, the electronic signals are sampled at a third sampling rate and sampled signals are A/D converted to generate digital signals. If the digital signals include a digital signal based on a component of the reflected light from the object, the digital signal is stored in the memory 41 (step S27). The third sampling rate is lower than the second sampling rate. As a result, the frequency at which the digital signals are stored in the memory 41 becomes lower than the frequency at step S26.

In the example shown in FIGS. 8 and 9, the sampling rate of the analog-to-digital converter 35 is changed continuously or stepwise in accordance with the distance to the object. The distance to the object is a value corresponding to the time of flight from the emission of the first light to the point in time at which the reflected light is received by the light receiver 4. Therefore, the distance measuring device 7 according to the third embodiment changes the sampling rate of the analog-to-digital converter 35 continuously or stepwise in accordance with the time of flight of the first light and its reflected light.

As described above, in the third embodiment, the sampling rate of the analog-to-digital converter 35 when it performs the A/D conversion is changed in accordance with the distance to the object. Therefore, the amount of data of the digital signals stored in the memory 41 may be reduced by reducing the sampling rate if the distance to the object is long. If the sampling rate is reduced, the measured distance error is increased. However, if the object is located at a distance, the allowable range of the measured distance error is wide. Therefore, there is no practical problem. If the distance to the object is short, the sampling rate is increased so that the measured distance error is minimized. As a result, the distance to the object may be measured highly accurately.

### Fourth Embodiment

In the third embodiment, the sampling rate for sampling the electrical signals outputted from the light receiving sensor 34 is changed in accordance with the distance to the object. However, the sampling rate may be constant, and the downsampling rate of the sampled digital signals may be changed in accordance with the distance to the object.

An electronic apparatus 1 according to a fourth embodiment has a block configuration shown in FIG. 1, but the operations of the analog-to-digital converter 35 included in the light receiver 4 and the memory controller 43 included in the signal processing unit 5 are different from those of the third embodiment.

The analog-to-digital converter 35 according to the fourth embodiment samples electrical signals from the light receiving sensor 34 at a constant sampling rate regardless of the distance to the object. Therefore, the analog-to-digital converter 35 outputs digital signals at constant time intervals regardless of the distance to the object. The digital signals outputted from the analog-to-digital converter 35 are inputted to the memory controller 43.

The memory controller 43 changes the downsampling rate of the digital signals in accordance with the distance to the object. More specifically, the memory controller 43 sets the downsampling rate to be lower if the distance to the object becomes shorter in order to store more digital signals in the memory 41 in a unit time, and to be higher as the distance to the object becomes longer in order to store less digital signals in the memory 41 in the unit time.

As a result, the frequency at which the digital signals are stored in the memory 41 may be reduced as the distance to the object becomes longer, thereby curbing the storage capacity of the memory 41 for storing the digital signals.

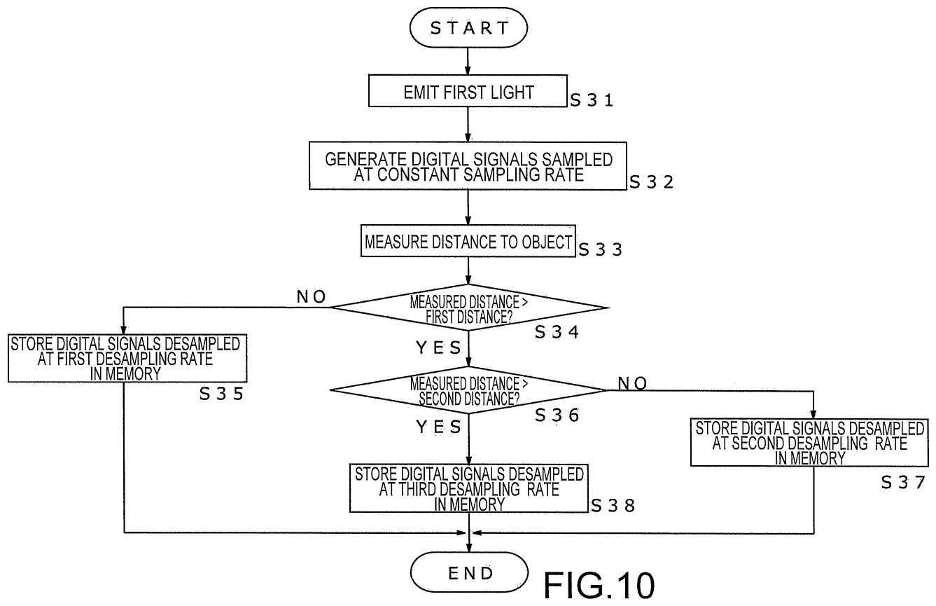

FIG. 10 is a flowchart of an operation of the electronic apparatus 1 according to the fourth embodiment. After the first light is emitted (step S31), the analog-to-digital converter 35 samples electrical signals outputted from the light receiving sensor 34 at a constant sampling rate and performs A/D conversion to generate digital signals (step S32).

Before or after step S32, the distance measurer 42 measures the distance to the object by any means (step S33). The memory controller 43 then determines whether the distance to the object is longer than a first distance (step S34). If the distance is not longer than the first distance, the digital signals obtained at the analog-to-digital converter 35 by sampling the electronic signals at the constant sampling rate and performing A/D conversion of the sampled electronic signals are reduced at a first downsampling rate and stored in the memory 41 (step S35). The digital signals stored in the memory have a component of the reflected light from the object.

If it is determined at step S34 that the distance to the object is not longer than the first distance, whether the distance to the object is longer than a second distance is determined (step S36). If it is determined that the distance to the object is not longer than the second distance, the digital signals obtained at analog-to-digital converter 35 by sampling the electronic signals at the constant sampling rate and performing A/D conversion of the sampled electronic signals are reduced at a second downsampling rate and stored in the memory 41 (step S37). The second downsampling rate is higher than the first downsampling rate, and therefore the frequency at which the digital signals are stored in the memory 41 becomes lower than that at step S35.

If it is determined at step S36 that the distance is longer than the second distance, the digital signals are reduced at a third downsampling rate and stored in the memory 41 (step S38). The third downsampling rate is greater than the second downsampling rate, and therefore the frequency at which the digital signals are stored in the memory 41 is lower than that at step S37.

As described above, in the fourth embodiment, the analog-to-digital converter 35 samples the electronic signals at a constant sampling rate and performs A/D conversion on the sampled signals. Therefore, the operation of the analog-to-digital converter 35 may be simplified. Furthermore, in the fourth embodiment, the digital signals sampled at the constant sampling rate and subjected to the A/D conversion are reduced at a downsampling rate that is set in accordance with the distance to the object, and stored in the memory 41. Therefore, as the distance is longer, the frequency at which the digital signals are stored may be reduced, thereby curbing the number of digital signals stored in the memory 41.

### Fifth Embodiment

In the first to fourth embodiments described above, the write rate for storing the digital signals corresponding to the received second light in the memory 41 is changed continuously or stepwise based on the elapsed time from the emission timing or the distance to the object. However, the write rate may be temporarily increased only during a specific period of time or when a specific distance is detected, in consideration of a case where it is needed to accurately measure the distance to an object when it is known that the object is present at a location corresponding to a specific period of time or at a specific distance.

An electronic apparatus 1 according to a fifth embodiment has the block configuration shown in FIG. 1, but the operation of the memory controller 43 included in the signal processing unit 5 is different from that of the first embodiment. The memory controller 43 sets the write rate for storing digital signals in the memory 41 in a period between a first point in time and a second point in time to be greater than a write rate for storing digital signals in the memory 41 in at least a part of a period before the first point in time, the first point in time corresponding to a first distance to an object and the second point in time corresponding to a second distance that is longer than the first distance. Alternatively, when a distance to an object is between a first distance and a second distance that is longer than the first distance, the memory controller 43 sets the write rate for storing the digital signals in the memory 41 to be higher than a write rate for storing the digital signals in the memory 41 when the distance to the object is shorter than the first distance.

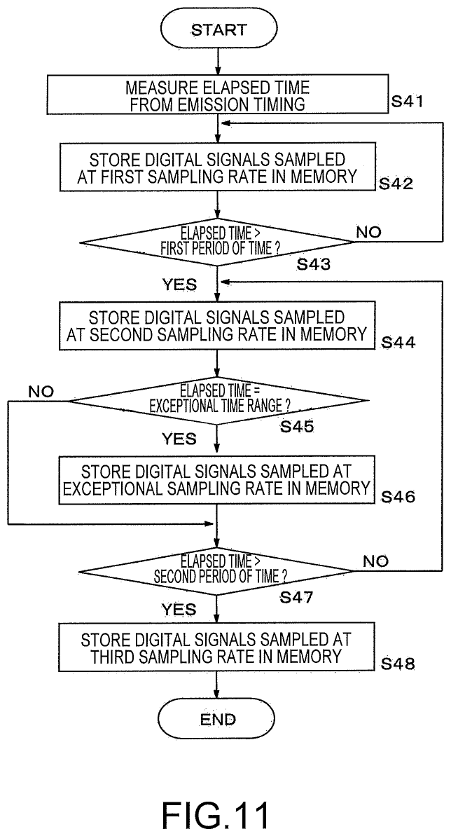

FIG. 11 is a flowchart showing an operation of the electronic apparatus 1 according to the fifth embodiment. The processes at steps S41 to S44 are the same as those of steps S1 to S4 shown in FIG. 4. After step S44, it is determined whether the elapsed time from the emission timing is within an exceptional time range (step S45), between a first point in time and a second point in time. The exceptional time rage is set when the distance to an object at a specific location needs to be accurately measured, for example.

If the elapsed time is determined to be within the exceptional time range at step S45, the memory controller 43 stores digital signals sampled at an exceptional sampling rate in the memory 41 (step S46). The exceptional sampling rate is, for example, higher than the first sampling rate.

After step S46, or if it is determined at step S45 that the elapsed time is not within the exceptional time range, it is determined whether the elapsed time reaches the second point in time (step S47). If the elapsed time does not reach the second point in time, the processes after step S44 are repeated. If the elapsed time has reached the second point in time, the memory controller 43 stores digital signals sampled at a third sampling rate in the memory 41 (step S48).

In the operation shown in FIG. 11, the sampling rate is switched. However, the downsampling rate may be switched when the digital signals are stored in the memory 41, as shown in FIG. 6. Specifically, when the elapsed time is determined to be within the exceptional time range, the downsampling rate may be temporality reduced. Furthermore, in the operation shown in FIG. 11, the sampling rate is switched based on the elapsed time from the emission timing. However, the sampling rate may be changed based on the distance to the object, as shown in FIG. 9. Specifically, when the distance to the object is determined to be within an exceptional distance range, the sampling rate may be temporarily raised. Alternatively, when the distance to the object is determined to be within the exceptional distance range as shown in FIG. 10, the downsampling rate may be temporarily lowered.

Thus, in the fifth embodiment, if the elapsed time from the emission timing is within the exceptional time range, or if the distance to the object is within the exceptional distance range, the sampling rate may be temporarily increased, or the downsampling rate for storing the digital signals to the memory 41 may be temporarily reduced. Therefore, the distance to an object at a specific location may be accurately measured.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electronic apparatus comprising:
a light receiver configured to receive a reception light including a reflected pulse generated by a reflection of an emitted pulse on an object;
an analog-to-digital converter configured to generate digital signals regarding the reception light;
a memory configured to store the digital signals;
a memory controller configured to control a write rate to write the digital signals to the memory in accordance with an elapsed time from emission timing of the emitted pulse; and
processor circuitry configured to measure a distance to the object based on a difference between the emission timing of the emitted pulse and reception timing of the reflected pulse.

2. The electronic apparatus according to claim 1, wherein the memory controller is further configured to reduce the write rate continuously or stepwise as the elapsed time becomes longer within at least a part of a period for receiving the reception light by the light receiver.

3. The electronic apparatus according to claim 1, wherein the memory controller is configured to control the write rate by changing a sampling rate of the analog-to-digital converter for sampling the reception light in accordance with the elapsed time.

4. The electronic apparatus according to claim 3, wherein the memory controller is configured to control the sampling rate of the analog-to-digital converter to be lower as the elapsed time is longer.

5. The electronic apparatus according to claim 1, wherein the memory controller is configured to control the write rate by changing a downsampling rate for downsampling the digital signal in accordance with the elapsed time.

6. The electronic apparatus according to claim 5, wherein the memory controller is configured to increase the downsampling rate for downsampling the digital signal continuously or stepwise as the lapse of time is longer.

7. The electronic apparatus according to claim 1, wherein the memory controller is configured to set a write rate for storing the digital signal in the memory in a period of time between a first point in time and a second point in time to be greater than a write rate for storing the digital signal in the memory at least in a period in the elapsed time before the first point in time, the first point in time corresponding to a first distance to the object and the second point in time corresponding to a second distance to the object, the second point in time being longer than the first distance.

8. An electronic apparatus comprising:
a light receiver configured to receive a reception light including a reflected pulse generated by a reflection of an emitted pulse on an object;
an analog-to-digital converter configured to generate digital signals regarding the reception light;
a memory configured to store the digital signals;
a distance measurer configured to measure a distance to the object based on a difference between the emission timing of the emitted pulse and reception timing of the reflected pulse; and
a memory controller configured to control a write rate for storing the digital signal in the memory in accordance with the distance to the object.

9. The electronic apparatus according to claim 8, wherein the memory controller reduces the write rate as the distance to the object is longer.

10. The electronic apparatus according to claim 8, wherein the memory controller is configured to control the write rate by changing a sampling rate of the analog-to-digital converter for sampling the reception light in accordance with the distance to the object.

11. The electronic apparatus according to claim 10, wherein the analog-to-digital converter reduces the sampling rate sampling the reception light continuously or stepwise as the distance to the object is longer.

12. The electronic apparatus according to claim 8, wherein the memory controller controls the write rate by changing a downsampling rate for downsampling the digital signal in accordance with the distance to the object.

13. The electronic apparatus according to claim 12, wherein the memory controller increases the downsampling rate for downsampling the digital signal continuously or stepwise as the distance to the object is longer.

14. The electronic apparatus according to claim 8, wherein when the distance to the object is between a first distance and a second distance that is longer than the first distance, the memory controller sets the write rate for storing the digital signal in the memory to be higher than a write rate for storing the digital signal in the memory when the distance to the object is shorter than the first distance.

15. The electronic apparatus according to claim 1, wherein the memory controller controls the write rate based on time of flight of the emitted pulse and the reception light from the emission timing at which the emitted pulse is emitted to a point in time at which the reception is received.

16. The electronic apparatus according to claim 1, wherein the distance measurer measures the distance to the object based on information on the reception light received by the light receiver at a first point in time and information on the reception light received by the light receiver at a second point in time that is earlier than the first point in time stored in the memory.

17. The electronic apparatus according to claim 1 further comprising a light emitter configured to emit the emitted pulse, wherein the distance measurer acquires the emission timing at which the emitted pulse is emitted.

18. A distance measuring method comprising:
receiving a reception light including a reflected pulse generated by a reflection of an emitted pulse on an object;
generating digital signals regarding the reception light;
controlling a write rate to write the digital signals to a memory in accordance with an elapsed time from emission timing of the emitted pulse; and
measuring a distance to the object based on a difference between the emission timing of the emitted pulse and reception timing of the reflected pulse.

19. The distance measuring method according to claim 18, wherein the write rate is continuously or stepwise reduced as the elapsed time becomes longer within at least a part of a period for receiving the reception light by the light receiver.

20. A distance measuring method comprising:
receiving a reception light including a reflected pulse generated by a reflection of an emitted pulse on an object;
generating digital signals regarding the reception light;
storing the digital signals in a memory;
controlling a write rate to write the digital signals to the memory in accordance with an elapsed time from emission timing of the emitted pulse; and
measuring a distance to the object based on a difference between the emission timing of the emitted pulse and reception timing of the reflected pulse.
